(19) United States
(12) Patent Application Publication
(10) Pub. No.: US 2009/0159726 A1
(43) Pub. Date: Jun. 25, 2009

(54) Drip tape loop with mat application

(75) Inventors: Hugh A. Thompson, Fairfield, OH (US); Thomas R. Kruer, Erlanger, KY (US)

Correspondence Address: EGBERT LAW OFFICES, 412 MAIN STREET, 7TH FLOOR, HOUSTON, TX, 77002, US

(73) Assignee: TOH Products LLC, Edgewood, KY (US)

(21) Appl. No.: 11/821,733

(22) Filed: Jun. 25, 2007

Related U.S. Application Data
(60) Provisional application No. 60/816,370, filed on Jun. 26, 2006.

(51) Int. Cl. B05B 15/00

(52) U.S. Cl. 239/542

(57) ABSTRACT

An irrigation drip tape loop configured so as to largely encircle a plant, and a method for fabricating it. A drip irrigation mat incorporating this drip tape loop so as to provide an irrigated, weed-free, highly-supportive growing environment for both commercial and residential plants as single units, or as rows.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to drip irrigation and weed suppression for promoting the growth and health of desirable plants.

More specifically, the invention related to a multi-functional product consistently supplying irrigation fluid to the root zones of desirable plants at low rates and with little runoff by a loop of drip tape while simultaneously suppressing growth of weeds and undesirable plants by an attached synthetic mulch sheet.

2. Description of Related Art Including Information Disclosed Under 37 CFR 1.97 and 37 CFR 1.98.

This multi-function product a relatively new concept in plant husbandry, has unique and challenging requirements. For optimum plant growth while avoiding contaminating runoff, very low rates of irrigation flow to the pant are desirable. The flow application needs to be uniform around the plant despite sloping soil topography, which uniformity generally requires significant exit resistance. Also the product preferably has good puncture resistance to prevent damage by thirsty insects. Prior art devices fail to meet these objectives and are less than fully successful.

Regarding looped irrigators, Mannin (U.S. Pat. No. 6,901,698 B2) describes a flexible soaker hose with a bendable internal conduit allowing the soaker hose to be shaped, for example, to largely encircle a tree.

Williams (U.S. Pat. No. 4,010,898) described a semi-looped conduit which distributes water around agricultural plants with spray nozzles.

Mackenzie Nursery Supply Inc. offers a “pressure compensated dribble ring” with a drip emitter attached upstream to limit total flow. (ww.mnsinc.cc/)

Regarding drip tape, Gilead et al (U.S. Pat. No. 4,413,787) describes a tortuous pressure-reducing pathway between two foils in the absence of a supply hose or tubular conduit.

Gilead (EP 0293857) devised a straight-line drip tape consisting of a tubular conduit with embossed connecting opposite edges which create a labyrinthine passage for liquid. Included are multiple embossed distribution conduits and first and second labyrinthine sections for pressure reduction.

Leal-Diaz (U.S. Pat. No. 4,047,995) developed a hose for drip irrigation by imprinting enclosure circuits on overlapped edge sections of the hose to produce water pressure reduction on exiting.

Regarding irrigation mates, Popa (U.S. Pat. No. 3,302,323) employs plastic sheet-like material which surrounds the plant and has beneath conduits containing orifice openings oriented at 45 degrees relative to fluid flow in the conduits. The conduits are bent in a substantially rectangular configuration and surround the plant.

Kruer and Thompson (U.S. Pat. No. 6,996,932 B2 and U.S. Pat. No. 6,997,402 B2) provide unitized drip irrigation mats having at least two polymeric material layers selectively bonded together to define fluid-conveying passageways. Also claimed is a drip irrigation mat wherein at least one of the distribution headers is comprised of a flow restricting means.

### BRIEF SUMMARY OF THE INVENTION

This invention involves a planar drip tape loop suitable, for example, for drip irrigation of desirable plants. The loop shape of this invention is an improvement over prior art drip tapes which are straight-line strips which do not lie flat when wrapped around the plant. Within the loop are provided primary and secondary flow restrictors leading to emitters.

Further, it provides designs of low total flow through the design of the primary flow restrictor The secondary flow restrictor provide equal output rates at multiple emitters around the plant regardless of ground slope or unevenness, unlike prior art loops. The drip tape loop is produced by modifying the embossing and laminating methods of prior art straight-line drip tapes.

The invention also includes a weed-suppressing drip irrigation mat which incorporates this drip tape loop. The planar loop configuration, rather than a strip one edge, is essential for secure attachment to the mat sheet. The drip irrigation mat of the present invention is well-suited for container-grown plants.

Thus an overall object of this invention is to provide a very-positive growing environment for both commercial and residential plants including drip irrigation and run-off control combined with non-chemical elimination of competing weeds.

It is a further objective to conserve water and fertilizer by dispensing these at very low rates and only to the root zone of each plant, and further, applying these uniformly despite sloping ground.

It is a further objective to provide insect bit resistance via the relatively thick-walled embossed drip tape.

It is still a further overall objective to provide these as a combination of benefits not previously obtainable, and to provide these in an economical product.

### BRIEF DESCRIPTION OF THE SEVERAL VIEWS OF THE DRAWINGS

FIG. 1 is a segmented plan view of the drip tape loop of the present invention—which lies flat in the plane of the loop-showing inlet, primary restrictor, header, secondary restrictors, and outlet emitters.

FIG. 2 is a cross-sectional view of the drip tape loop of FIG. 1 showing the three flow passageways which lie in the plane of the loop.

FIG. 3 is a perspective view of the irrigating mat of the present invention, including a cut-away showing the drip tape loop.

FIG. 4 is an alternative embodiment of the drip tape loop, including slots which decrease the in-lane stiffness and facilitate forming the loop, while simultaneously providing more length for flow passages.

FIG. 5 illustrates the aspects of a chilling and cutting process for forming the in-plane loops and depositing them on the sheet preparatory to bonding to the mat.

FIG. 6 shows an alternative embossing concept in which the loop curvature is generated simultaneous with the embossing.

### DETAILED DESCRIPTION OF THE INVENTION

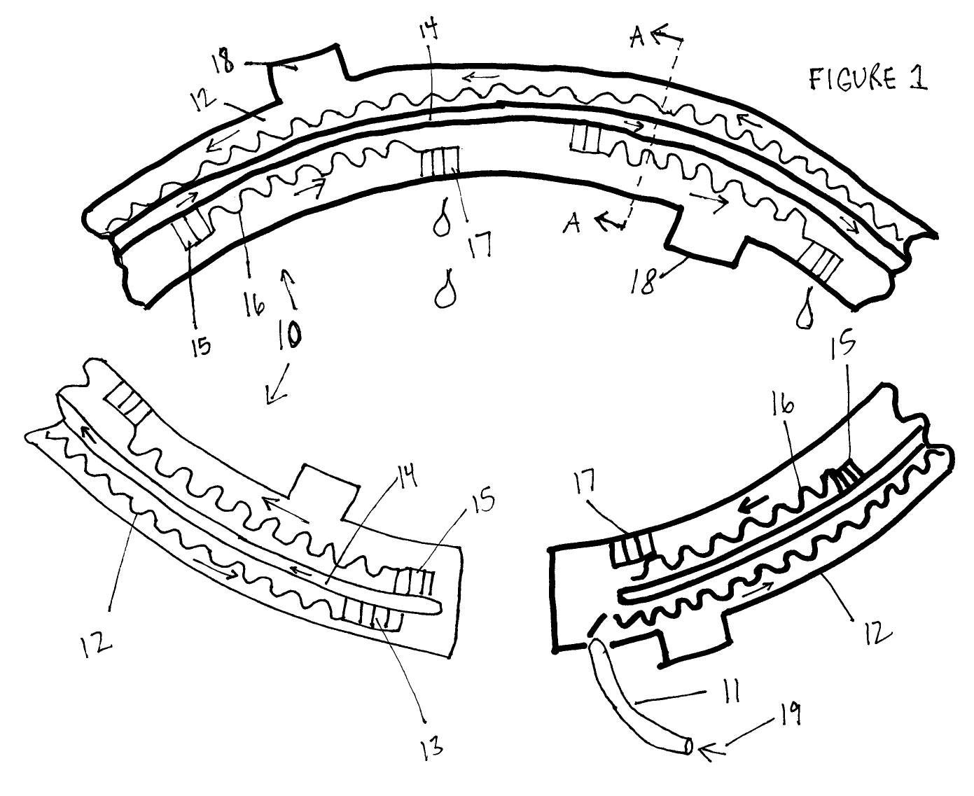

FIG. 1 is a segmented plan view of the drip tape loop 10 of the present invention. The inlet tube 11 provides irrigation fluid 19 to the embossed primary restrictor 12 which largely encircles the loop to the multiple-path connector 13. This connects to the header 14 which circles back around the loop. Multiple connector 15 connect the header to multiple secondary restrictors 16 connected to emitters 17. Optional tabes 18 provide convenient attachment points.

Importantly, as an option, the header can be relatively small and/or tortuous, in which case downstream secondary restrictors are shorter/less resistive so that flows at the different emitters are essentially equal.

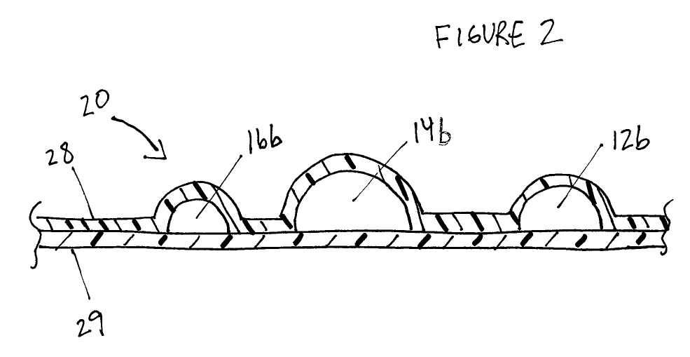

FIG. 2 is a cross-section 20 of the drip tape loop of FIG. 1. Between the embossed layer 28 and planar layer 29 are formed passageways for the primary restrictor 12b, header 14b, and secondary restrictor 16b. Again, the sizes may be of various proportions depending on the specific design.

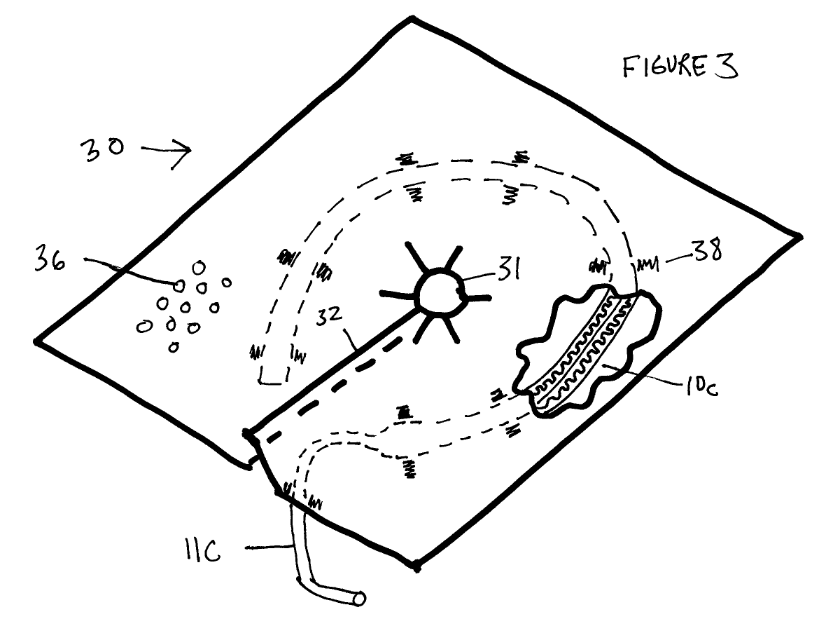

The application of the drip tape loop to irrigate a single plant is the subject of FIG. 3. In the drip irrigation mat 20, the drip tape loop 10c essentially encircles the plant for which an expandable plant opening 31 and an installation seam 32 are provided.

The mat body is an ultra-violet-resistant sheet material sized and shaped to generally cover the area above the pant root zone. It may include appropriate optical properties for reflection or absorption of various wavelengths. Sheet materials may include polymeric film, non-woven or woven fabrics, paper, foam or combinations of these. Irrigation fluid is provided by supply tube 11c. Optional aeration holes 36 are provided.

Attachment of the drip tape loop 10c to the mat body 34 is facilitated by the tabs 18 which can be attached by intermittent bonds 38 by known techniques including plastic welding, heat sealing, hot melt adhesive, pressure-sensitive adhesive, sewing, laser welding, and the like. In general, durable materials and attachment methods are used to provide for multi-season, multi-year use.

It will be noted that the drip tape loop 10c must lie flat in its plane in order to be securely attached to the mat body 34.

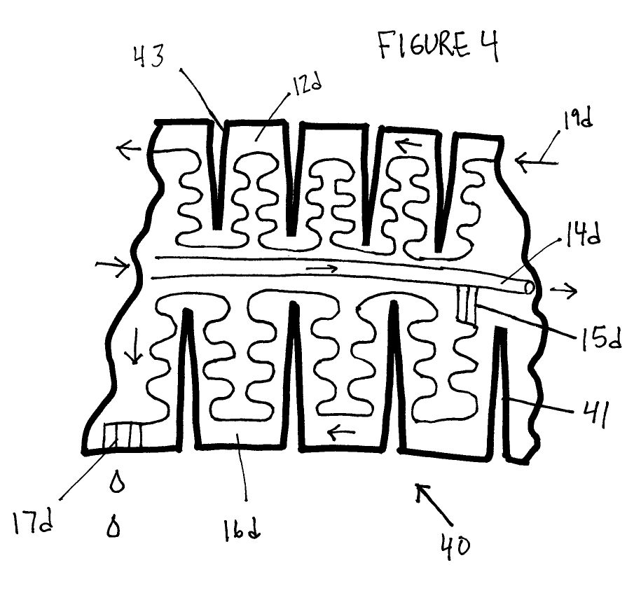

FIG. 4 shows an alternative design for the drip tape loop 40 in plan view. Inner notches 41 and outer slits 43 allow for in-plane bending of the drip tape loop 40 without the need for heat or special processing after a straight strip has been embossed, laminated, or slotted. Another benefit of this alternative design is that more space is provided for primary restrictors 12d and secondary restrictors 16d, thus allowing more restrictor length and more flow restriction if desired. Again, distributor 14d may be configured to avoid sediment. Connectors 1d and emitters 17d are unchanged, as is irrigation fluid 19d.

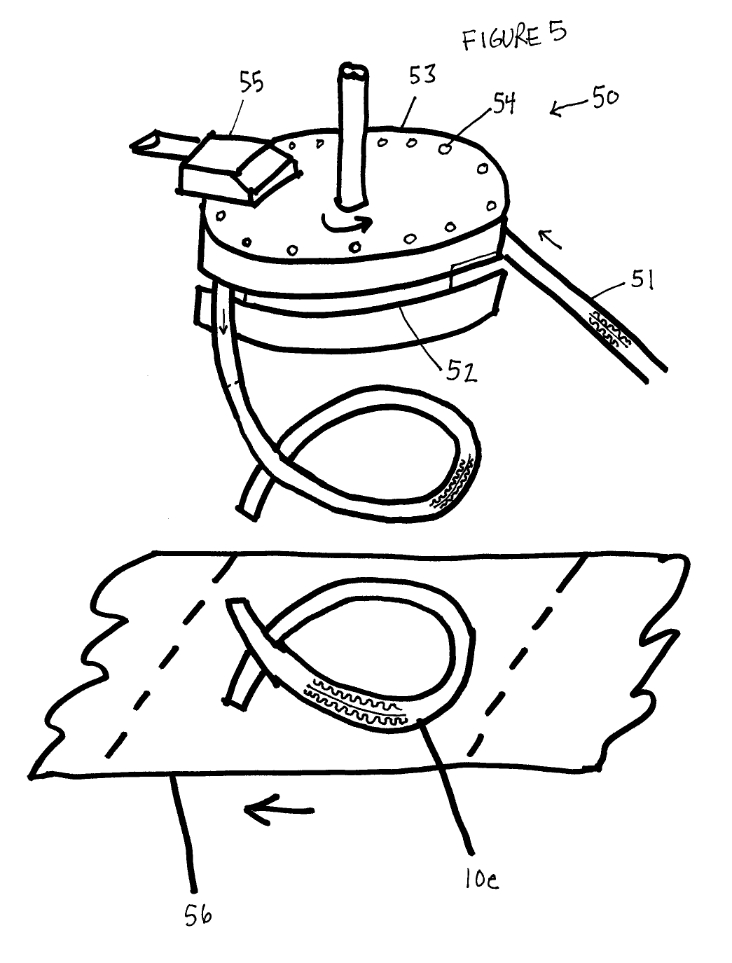

FIG. 5 shows a process 50 for achieving in-lane drip tape loops from previous embossed and laminated straight contiguous strips. A straight continuous strip 51 is preheated until soft (process not shown), then wrapped onto a confining slot 52 in the chilled roll 53. This bends and differentially stretches the outer sections of the soft strip to produce in-plane curvature. The loops are periodically cut (device not show) while, through ports 54, the vacuum box 55 clamps the strip to prevent loss of in-feed. Completed loops 10e are deposited onto continuous sheet 56 for later bonding, thus assembling the drip irrigation mat 30.

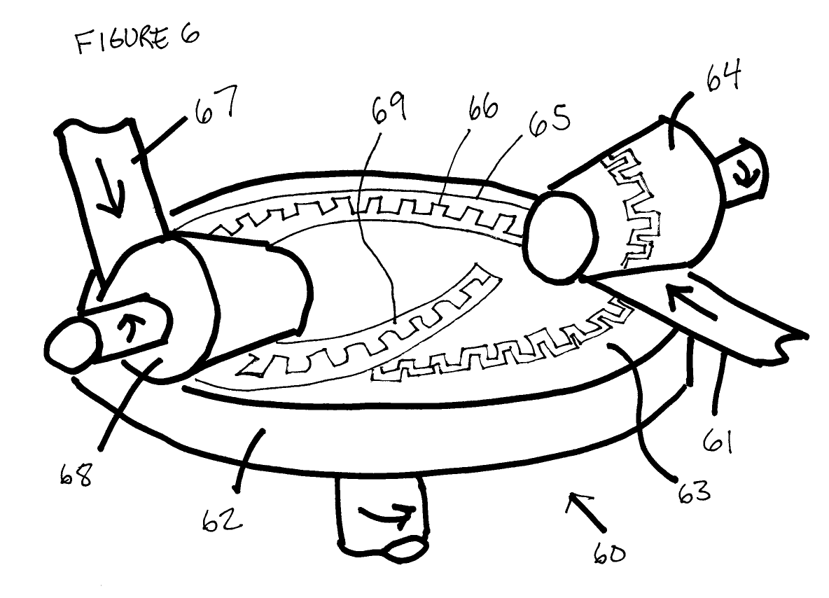

FIG. 6 shows a perspective view of an alternative process 60 for fabricating the drip tape loops 10e. Strip plastic stock 61 is fed into a mal/female embossing nip between heated turntable 62 with pattern 63 and heated, synchronized, patterned, conical roller 64 (meshing like bevel gears) to produce the curved strip 65 having embossed pattern 66 in its surface.

Cover plastic strip 67 is bonded in place by heat and pressure from a smooth conical roller 68. The embossing patterns of the turntable and rollers are configured to build in the desired in-lane curvature into the completed, curved drip tape 69 simultaneous with producing its embossing and lamination. Take-away and cutting equipment (not shown) cuts this curved drip tape 69 into separate loops 10 (not shown).

We claim:

1. A slender, compact, laminated drip irrigation loop substantially encircling at least one plant, said loop comprised of at least two polymeric material layers selectively bonded together to define fluid conveying passageways, said fluid conveying passageways comprising in sequence an inlet means, a primary flow restrictor, a header, a secondary flow restrictor, and an outlet means, all in fluid communication with each other.

2. The irrigation loop of claim 1 having a curved shape and lying substantially flat within the plane of the loop.

3. The irrigation loop of claim 1 having edge margins or tabs suitable for attachment to a sheet-type material.

4. The irrigation loop of claim 1 having periodic radial slits to provide additional length for fluid conveying passageways and to facilitate curvature without out—f-lane protrusion.

5. The irrigation loop of claim 1 wherein the header is simultaneously a flow restrictor, and further wherein downstream secondary flow restrictors have less flow resistance than upstream secondary flow restrictors to provide substantially—equal output flow at each outlet means.

6. A multi-functional, puncture-resistant drip irrigation mat which includes the drip tape loop attached to a synthetic mulch sheet to form a drip irrigation mat, said mat being sized and shaped to cover an area immediately around at least one plant.

7. The drip irrigation mat of claim 6 having an opening which the plant extends therethrough.

8. The drip irrigation mat of claim 6 including an installation seam extending from said opening to an outer edge of the mat.

9. The drip irrigation mat of claim 6 wherein uniform output rates are obtained at multiple locations around the at least one plant irrespective of ground slope or contour around the at least one plant.

10. The drip irrigation mat of claim 6 wherein the mulch sheet is comprised of a polymeric film, a nonwoven fabric, a woven fabric, a foam, paper or a combination of these.
